(19) United States
(12) Patent Application Publication
(10) Pub. No.: US 2008/0174397 A1
(43) Pub. Date: Jul. 24, 2008

(54) High quality factor, low volume, air-core inductor

(75) Inventors: Michael Andrew de Rooij, Schenectady, NY (US); William Edward Burdick, Niskayuna, NY (US); James Wilson Rose, Guilderland, NY (US)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/655,412

(22) Filed: Jan. 19, 2007

(51) Int. Cl. H01F 37/00; H01F 5/00; H01F 41/04

(52) U.S. Cl. 336/200; 29/602.1

(57) ABSTRACT

A spirally-wound inductor having a tapered conductor. The height of the conductor increases from a smaller height near the center of the inductor to a greater height at the outer edge of the inductor. A spherically-shaped inductor and methods for manufacturing the spherically-shaped inductor. The spherically-shaped inductor has a series of coils that increase in diameter from each end toward the middle.

### BACKGROUND

The invention relates generally to inductors, and more particularly to air-core inductors having different diameter coils and the techniques for making them.

Many electrical devices use inductors. An inductor is a passive electrical device that is employed in electrical circuits because of its property of inductance. An electric current flowing through a conductor will produce a magnetic field. An inductor is typically arranged to “store” the magnetic field produced when an electrical current flows through it and, conversely, can produce a current from breakdown of the stored magnetic field when the initial current is removed. A typical inductor is wound as a solenoid and resembles a spring or helical winding. It consists of wire wound into a series of coils, forming a cylinder. The magnetic field generally surrounds the coils of wire when current is applied, in accordance with the right hand rule.

Real inductors are not 100% efficient. They do not convert all of the current flowing through the inductor into a magnetic field or store all of the magnetic field that is produced (i.e., cannot completely efficiently generate current when the field breaks down). Some of the current flowing through the inductor will produce heat due to the electrical resistance of the inductor, which is simply one of the physical properties of the material used as the conductor. However, other factors may increase further the resistance of the inductor. For example, what is referred to as the “skin effect” may cause the resistance of the inductor to increase at high frequencies of applied current.

One measure of the efficiency of an inductor is known as the quality factor, or “Q”. One method of determining the value of the Q of an inductor is to establish the ratio of the inductive reactance of the inductor at a given frequency of electrical current to its electrical resistance, where the inductive reactance is the product of the frequency of the electrical current flowing through the inductor and the inductance of the inductor. Mathematically, this is represented in the equation below:

Q=ωL/R (1)

where: Q=quality factor;

ω=frequency in radians;

L=inductance in Henry's; and

R=electrical resistance in ohms.

Existing inductors that have large quality factor values also have relatively large volumes. As with most electrical components, it is better to have an inductor that is smaller, rather than larger, for a given quality factor and inductance. Therefore, a need exists for an inductor that combines a high quality factor and/or a smaller volume for a given inductance.

### BRIEF DESCRIPTION

In one aspect of the present technique, a spirally-wound inductor having a tapered conductor is presented. The height of the conductor increases from a smaller height near the center of the inductor to a greater height at the outer edge of the inductor. Typically, increasing the surface area of a conductor lowers its resistance. However, when the conductor is exposed to a varying magnetic field, a greater surface area will cause greater inductive heating in the conductor and a rise in resistance. Inductive heating occurs when there are variations in the magnetic field to which a conductor is exposed, which induces eddy currents to flow in the conductor. The eddy currents cause the temperature of the conductor to rise, which causes the resistance of the conductor also to rise.

In the spirally-wound inductor, the magnetic field is strongest near the center and weakest at the outer edge. Having a smaller height near the center reduces the surface area of the conductor that is perpendicular to the magnetic field where the magnetic field is strongest. This reduces inductive heating of the conductor. Therefore, by reducing the amount of inductive heating, the rise in resistance of the inductor that is caused by inductive heating is reduced. By increasing the height of the conductor as the strength of the magnetic field, and inductive heating, decreases, the resistance of the conductor is lowered by the increase in surface area to a greater extent than the inductive heating acts to increase the resistance.

In another aspect of the present technique, a spherically-shaped inductor is presented. The spherically-shaped inductor has a series of coils that increase in diameter from each end toward the middle. An electrical component may be located inside the sphere formed by the spherically-shaped inductor.

In another aspect of the present technique, methods of manufacturing a spherically-shaped inductor are presented. The spherically-shaped inductor may be wound around a spherical form. The spherical form may then be removed using any of a number of different techniques, leaving the spherically-shaped inductor. Alternatively, the spherically-shaped inductor may be formed from a pattern that enables the inductor to be cut from a conductive material into two spiral halves, then folded and expanded like an accordion to form a spherical shape.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an magnetic resonance system for use in medical imaging, in accordance with an exemplary embodiment of the present technique;

FIG. 2 is a perspective view of a spirally-wound inductor, in accordance with an exemplary embodiment of the present technique;

FIG. 3 is an elevation view of the inductor prior to being spirally-wound, in accordance with an exemplary embodiment of the present technique;

FIG. 4 is a cross-sectional view of the inductor of FIG. 2, taken generally along line 4-4 of FIG. 2;

FIG. 5 is a computer-generated plot of a cross-sectional view of the magnetic flux lines produced by an electric current flowing through the inductor of FIG. 2, in accordance with an exemplary embodiment of the present technique;

FIG. 6 is a perspective view of a spherically-shaped inductor, in accordance with an alternative exemplary embodiment of the present technique;

FIG. 7 is a computer-generated plot of a cross-sectional view of the magnetic flux lines produced by an electric current flowing through the inductor of FIG. 6, in accordance with an exemplary embodiment of the present technique; and

FIG. 8 is an elevation view of a conductor used to form the inductor of FIG. 6, in accordance with an exemplary embodiment of the present technique.

### DETAILED DESCRIPTION

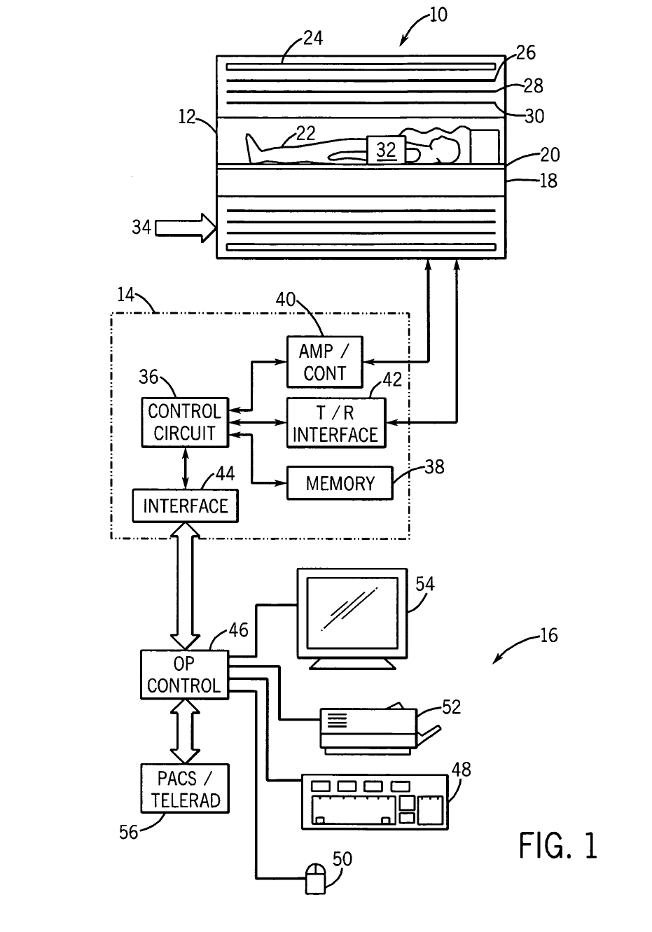

Turning now to the drawings, and referring generally to FIG. 1, a magnetic resonance (“MR”) system 10 is illustrated. The illustrated MR system 10 including a scanner 12, scanner control system 14, and an operator interface station 16. While MR system 10 may include any suitable MR scanner or detector, the illustrated system includes a full body scanner comprising a patient bore 18 into which a table 20 may be positioned to place a patient 22 in a desired position for scanning.

A primary magnet coil 24 is provided for generating a main magnetic field that is aligned generally with patient bore 18. A series of gradient coils 26, 28 and 30 are arranged around the patient bore 18 to enable controlled magnetic gradient fields to be generated during examination sequences, as will be described more fully below. In this embodiment, a radio frequency (“RF”) coil 32 is coupled to scanner control system 14 to transmit and receive RF pulses. The RF coil 32 transmits an RF pulse into the patient to excite gyromagnetic material within the tissues of the patient. RF coil 32 also serves as a receiving coil for receiving signals transmitted from the gyromagnetic material in the tissues of the patient 22. However, separate transmitting and receiving coils may be used. In this embodiment, RF coil 32 is specifically configured for use in forming images of the internal anatomical features of the thorax, such as the heart and lungs. Other embodiments of RF coil 32 may be specifically adapted for use with other anatomical features, such as the head. A power supply, denoted generally by reference numeral 34 in FIG. 1, is provided for energizing the primary magnet coil 24.

In a present configuration, the gradient coils 26, 28 and 30 have different physical configurations adapted to their function in the MR system 10. As will be appreciated by those skilled in the art, the coils are comprised of conductive wires, bars or plates which are wound or cut to form a coil structure which generates a gradient field upon application of controlled pulses as described below. The placement of the coils within the gradient coil assembly may be done in several different orders, but in the present embodiment, a Z-axis coil is positioned at an innermost location, and is formed generally as a solenoid-like structure which has relatively little impact on the primary magnetic field. Thus, in the illustrated embodiment, gradient coil 30 is the Z-axis solenoid coil, while gradient coil 26 and gradient coil 28 are Y-axis and X-axis coils respectively.

As will be appreciated by those skilled in the art, when the gyromagnetic material bound in tissues of the patient is subjected to the primary magnetic field, individual magnetic moments of the magnetic resonance-active nuclei in the tissue partially align with the field. While a net magnetic moment is produced in the direction of the polarizing field, the randomly oriented components of the moment in a perpendicular plane generally cancel one another. During an examination sequence, an RF pulse at or near the Larmor frequency of the material of interest is transmitted by the RF coil 32 into the patient 22, resulting in rotation of the net aligned moment to produce a net transverse magnetic moment. This transverse magnetic moment precesses around the primary magnetic field direction, emitting RF (magnetic resonance) signals. For reconstruction of the desired images, these RF signals are detected by RF coil 32 and processed.

Gradient coils 26, 28 and 30 serve to generate precisely controlled magnetic fields, the strength of which vary over a predefined field of view, typically with positive and negative polarity. When each coil is energized with known electric current, the resulting magnetic field gradient is superimposed over the primary field and produces a desirably linear variation in the Z-axis component of the magnetic field strength across the field of view. The field varies linearly in one direction, but is homogenous in the other two. The three coils have mutually orthogonal axes for the direction of their variation, enabling a linear field gradient to be imposed in an arbitrary direction with an appropriate combination of the three gradient coils.

The pulsed gradient fields perform various functions integral to the imaging and tracking process. For imaging, some of these functions are slice selection, frequency encoding and phase encoding. These functions can be applied along the X-, Y- and Z-axis of the original physical coordinate system or in various physical directions determined by combinations of pulsed currents applied to the individual field

coils. The coils of scanner 12 are controlled by scanner control system 14 to generate the desired magnetic field and RF pulses. In the diagrammatical view of FIG. 1, scanner control system 14 comprises a control circuit 36 for commanding the pulse sequences employed during the examinations and for processing received signals. For example, control circuit 36 applies analytical routines to the signals collected in response to the RF excitation pulses to reconstruct the desired images and to determine device location. Control circuit 36 may include any suitable programmable logic device, such as a CPU or digital signal processor of a general purpose or application-specific determiner. In this embodiment, scanner control system 14 also includes memory circuitry 38, such as volatile and non-volatile memory devices for storing physical and logical axis configuration parameters, examination pulse sequence descriptions, acquired image data, acquired tracking data, programming routines, and so forth, used during the examination sequences implemented by scanner 12.

The interface between the control circuit 36 and the coils of scanner 12 is managed by amplification and control circuitry 40 and by transmitter and receiver interface circuitry 42. Amplification and control circuitry 40 includes amplifiers for each gradient field coil to supply drive current to the field coils in response to control signals from control circuit 36. Transmitter and receiver interface circuitry 42 includes additional amplification circuitry for driving RF coil 32. Moreover, where the RF coil 32 serves both to transmit and to receive, as illustrated in this embodiment, transmitter and receiver interface circuitry 42 will typically include a switching device for toggling the RF coil 32 between an active or transmitting mode, and a passive or receiving mode. Transmitter and receiver interface circuitry 42 further includes amplification circuitry to amplify the signals received by RF coil 32. In the illustrated embodiment, transmitter and receiver interface circuitry has a low noise amplifier section comprising a plurality of inductors. As will be discussed in more detail below, these inductors have a high Q value to ensure the best possible signal-to-noise ratio. Finally, scanner control system 14 also includes interface components 44 for exchanging configuration and image and tracking data with operator interface station 16, in this embodiment.

It should be noted that, while in the present description reference is made to a horizontal cylindrical bore imaging system employing a superconducting primary field magnet assembly, the present technique may be applied to various other configurations, such as scanners employing vertical fields generated by superconducting magnets, permanent magnets, electromagnets or combinations of these means. Additionally, while FIG. 1 illustrates a closed MRI system, the embodiments of the present invention are applicable in an open MRI system which is designed to allow access by a physician.

Operator interface station 16 may include a wide range of devices for facilitating interface between an operator or radiologist and scanner 12 via scanner control system 14. In the illustrated embodiment, for example, an operator controller 46 is provided in the form of a work station. The station also typically includes memory circuitry for storing examination pulse sequence descriptions, examination protocols, user and patient data, image data, both raw and processed, and so forth. The station may further include various interface and peripheral drivers for receiving and exchanging data with local and remote devices. In the illustrated embodiment, such devices include a conventional keyboard 48 and an alternative input device such as a mouse 50. A printer 52 is provided for generating hard copy output of documents and images reconstructed from the acquired data. A monitor 54 is provided for facilitating operator interface. In addition, MR system 10 may include various local and remote image access and examination control devices, represented generally by reference numeral 56 in FIG. 1. Such devices may include picture archiving and communication systems, teleradiology systems, and the like.

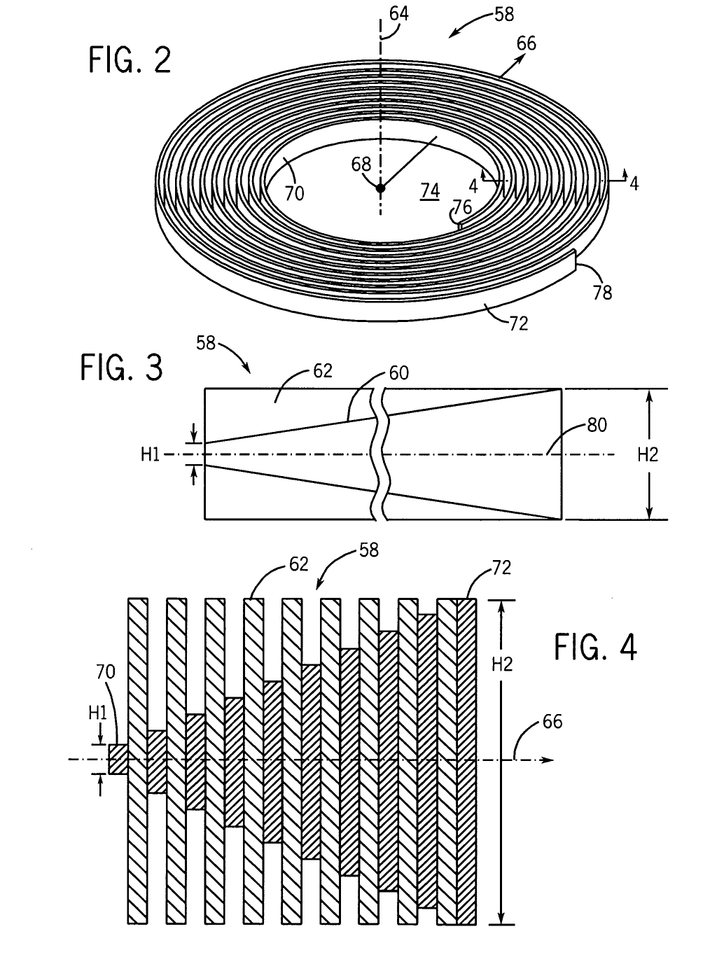

Referring generally to FIGS. 2 and 3, a novel inductor 58 used in the low noise amplifier section of the transmitter and receiver interface circuitry 42 of FIG. 1 is illustrated. As will be discussed in more detail below, the inductor 58 is an air-core inductor that has a higher quality factor and a smaller volume for the same inductance compared to previous air-core inductors. In this embodiment, the inductor 58 is comprised of an electrically-conducting material (hereinafter referred to as “conductor”) 60, disposed on an electrically-insulating base layer (hereinafter referred to as “substrate”) 62. The conductor 60 and substrate 62 are flexible. This enables the conductor 60 and substrate 62 to be spirally wound about an axis 64 through the inductor 58. Thus, the coils of the inductor 58 are concentric and have an increasing diameter. The coils of typical inductors have the same diameter and are arranged cylindrically, like a spring. Each point on the conductor 60 is located at a distance along a radius 66 from the center 68 of the inductor 58. The substrate 62 prevents the conductor 60 from self-shorting. In this embodiment, the inductor 58 has ten coils, including an inner coil 70 and an outer coil 72. In the illustrated embodiment, the conductor 60 and substrate 62 are wound with the conductor 60 facing inward toward the center 68 of the inductor 58. However, the opposite arrangement may be used. As noted above, the inductor 58 has an air core 74. Alternatively, an insulting material may be placed in the space occupied by the air core 74. In addition, the conductor 60 has a first end 76 and a second end 78 that serve as terminals for connecting the inductor 58 electrically to other components.

Referring generally to FIGS. 3 and 4, a novel characteristic of the inductor 58 is that the height of the conductor 60 is tapered from the first end 76 to the second end 78. At the first end 76, the conductor 58 has a height “H1”. At the second end 78, the conductor has a height “H2”, which is greater than the height “H1”. In this embodiment, the height of the conductor 60 increases linearly along the length of the inductor 58. In addition, the conductor 60 is tapered symmetrically at the top and the bottom so that the conductor 60 remains centered about a longitudinal axis 80 centered along the substrate 62. As a result, the coils of the conductor 60 also remain centered on the radius 66 extending outward from the center 68 of the inductor 58. The conductor 60 may be comprised of copper or some other conductive material, such as carbon nano-tube material. The height of the conductor 60 at the first end 76 and second end 78 may be non-tapered to facilitate connection. In addition, the height of the conductor 60 may be varied in other configurations, such as a non-linear increase in height, or a series of step increases in height. For example, the conductor 60 height may vary so that each coil has a constant height, but the height increases for each coil from the inner coil 70 to the outer coil 72.

Tapering the height of the conductor 60 from the first end 76 to the second end 78 produces a reduction in the electrical resistance of the inductor 58. As noted above, the quality factor of the inductor 58 is inversely proportional to its electrical resistance. Thus, the quality factor of the inductor 58 increases by decreasing the electrical resistance of the conductor 60. Normally, increasing the surface area of a conductor will decrease its electrical resistance. Conversely, reducing the surface area of the conductor 60 will normally increase its electrical resistance. However, the resistance of the conductor 60 may be affected by other factors, such as temperature. An increase in the temperature of the conductor 60 may be caused by eddy currents induced in the conductor 60 by a magnetic field. In fact, the electric current flowing through the conductor 60 can produce a magnetic field that affects the resistance of the inductor 58. However, other components may also produce magnetic fields that affect the resistance of the inductor 58. As will be discussed in more detail below, the effect that the electric current flowing through the conductor 60 has to induce eddy currents in the conductor 60 is reduced by decreasing the height of the conductor 60 in the regions of the inductor 58 where the magnetic field is strongest. In addition, the height of the conductor 60 is gradually increased to provide greater surface area as the strength of the magnetic field decreases.

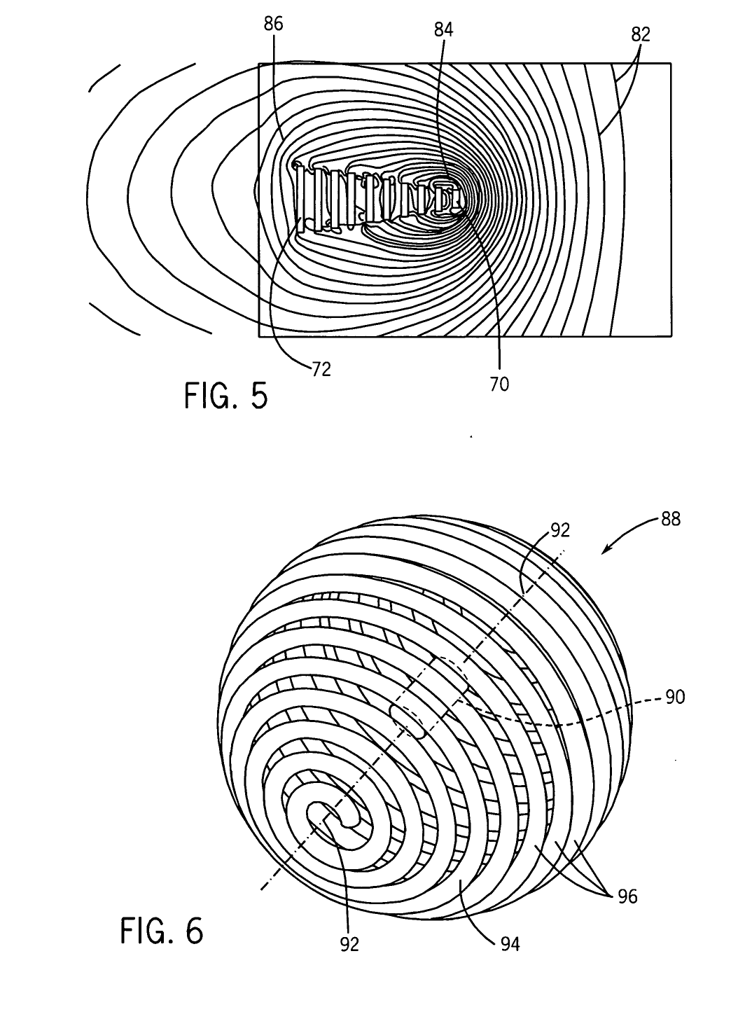

Referring generally to FIG. 5, a computer program was used to simulate the magnetic field produced by electric current flowing through the conductor 60. The magnetic field is represented in FIG. 5 by magnetic flux lines 82. The closer the flux lines 82 are to each other, the stronger the magnetic field. Thus, it can be seen that the magnetic field is strongest in the region of the air core 74 adjacent to the inner coil 70 of the conductor 60. In addition, the magnetic field weakens from the region adjacent to the inner coil 70 of the conductor 60 outward along the radius 66 of the inductor 58 toward the outer coil 72 of the conductor 60. In addition, there are portions 84 of the magnetic flux lines 82 that are perpendicular to the height of the conductor 60 and other portions 86 of the magnetic flux lines 82 that are parallel to the height of the conductor 60. The portions 84 of the magnetic flux lines 82 that are perpendicular to the height of the conductor 60 are the flux lines 82 that induce eddy currents in the conductor 60. These eddy currents cause the temperature of the conductor 60 to increase, thereby raising its resistance. Therefore, by reducing the height of the conductor 60 where the magnetic field is strongest, fewer eddy currents are produced and the subsequent increase in electrical resistance that is caused by eddy currents is reduced. As noted above, normally the resistance of a conductor is reduced by increasing its surface area. Therefore, the electrical resistance of the conductor 60 can be minimized by increasing the height of the conductor 60 as the strength of the magnetic field decreases and the effect that the eddy currents have on increasing the electrical resistance of the conductor 60 is reduced. In the illustrated embodiment, this goal is achieved by tapering the height of the conductor 60 along its length so that as the conductor 60 is spirally wound, the height of the conductor 60 increases as its distance from the center 68 of the inductor 60 increases. However, other configurations may be used to minimize the electrical resistance of the inductor 58 in view of the competing effects that increased surface area and eddy currents have on the electrical resistance of the conductor 60 within the inductor 58. For example, as noted above, the conductor 60 may have step increases in height along its length. Alternatively, the conductor 60 may have a height that gradually tapers along its length until a desired height is achieved and then that height is maintained over a length of the conductor 60.

Referring generally to FIG. 6, an embodiment of a spherically-shaped inductor 88 is provided. In the illustrated embodiment, the spherically-shaped inductor 88 is formed around a capacitor 90. The capacitor 90 has leads 92 that may be connected to the spherically-shaped inductor 88 to form a resonant circuit. The spherically-shaped inductor 88 has a conductor 94 that is wound in such a manner as to form a series of windings 96 that form a generally spherical shape. The spherical-shaped inductor 88 has a lower resistance than conventional inductors because there are few areas where the magnetic flux lines cut the conductor 94 perpendicular to the surface of the conductor 94. In the illustrated embodiment, the cross-section of the conductor 94 is round, such as the cross-section of a wire. However, the conductor 94 may have a rectangular or flat cross-section, such as the conductor 60 in the embodiment described above. In addition, the spherically-shaped inductor 88 may be disposed around a spherically-shaped insulating material.

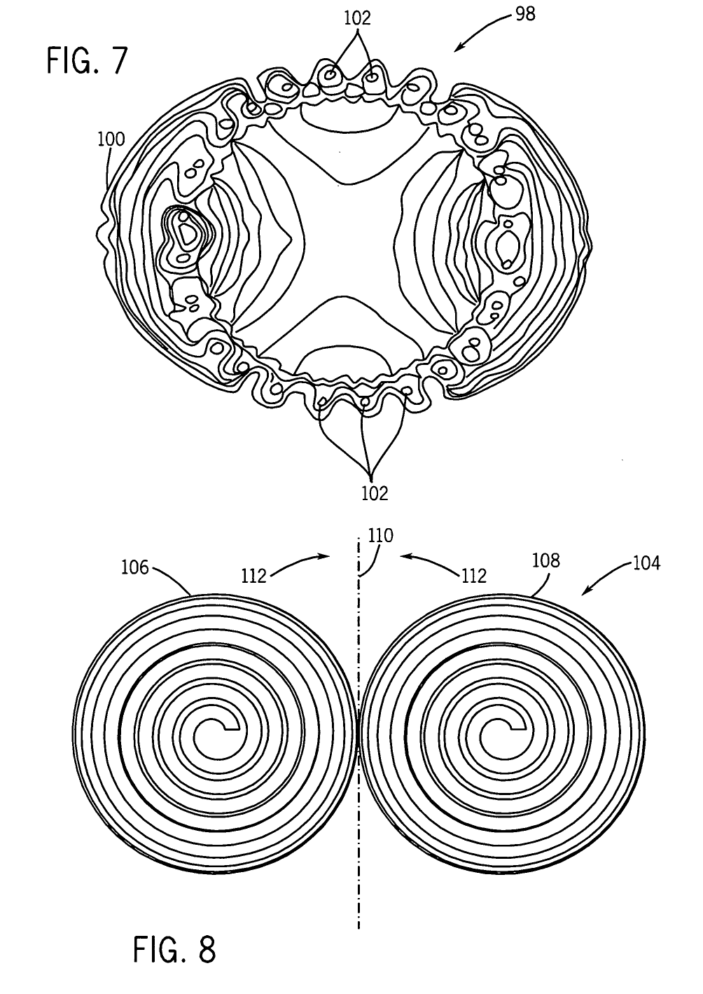

Referring generally to FIG. 7, a computer-generated simulation of the magnetic field produced through a cross-section of a spherically-shaped inductor 98 is provided. A different conductor shape was used in the computer program than in the embodiment illustrated in FIG. 6. For ease of computation, a conductor having a hexagonal-shaped cross-section, rather than a round cross-section, was used to generate the plot of the magnetic field around the spherically-shaped inductor 88. In the illustrated embodiment, the magnetic field generated by an electric current flowing through the spherically-shaped inductor 98 is represented by magnetic flux lines 100. It should be noted that there are few or no magnetic flux lines 100 that extend perpendicularly to the locations of conductors 102 of the spherically-shaped inductor 98. Thus, there are few or no eddy currents induced in the conductors 102 of the spherically-shaped inductor 98 that might cause the electrical resistance of the conductors 102 to increase due to heating.

One of the benefits of the spherical shape of the spherically-shaped inductor 88 is that the inductor 88 acts as a Faraday cage, also known as a Faraday shield. A Faraday cage is an enclosure that is formed by conducting material to shield the interior of the enclosure from external electric fields. Electric charges in the enclosing conductor repel each other and will, therefore, always reside on the outside surface of the enclosure. Any external electrical field acting on the enclosure will cause the electric charges on the enclosure to rearrange so as to completely cancel the external electric field effects on the interior of the enclosure. One application for the use of a Faraday cage is to protect electronic components from electrostatic discharges.

One method of manufacturing the spherically-shaped inductor 88 is to form a sphere from an insulating material and coating it with a conductive material. A groove may then be scribed in the conductive material around the sphere to form the windings. Alternatively, a conductive wire may be wrapped around the sphere. In addition, the insulating material may be a wax, or some other dissolvable or removable material, such that the sphere may be removed leaving only the conductive material to form the inductor.

Referring generally to FIG. 8, yet another method of manufacturing a spherically-shaped inductor is illustrated. This method is similar to methods used to form Japanese lanterns. In this embodiment, a conductive material is cut to form a “figure 8” shape 104 having two spiral halves: a left half 106 and a right half 108. The two halves 106, 108 are then folded at the center 110. The two halves may then be expanded like an accordion to form a sphere. Alternatively, rather than cutting a conductive material, the conductive material may be wound on a model to form the desired “figure 8” shape.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An inductor, comprising:
a conductive material spirally-wound about a center to form a plurality of coils arranged concentrically, wherein the conductive material has a height that is tapered over a portion of its length so that an inner coil has a shorter height than an outer coil.

2. The inductor as recited in claim 1, wherein the conductive material is tapered symmetrically along the portion of the length of the conductive material.

3. The inductor as recited in claim 2, wherein the height of the conductive material increases linearly over the portion of its length.

4. The inductor as recited in claim 1, comprising:
an electrically insulating strip, wherein the conductive material is disposed on the electrically insulating strip.

5. The inductor as recited in claim 4, wherein the insulating strip has a constant height over its length.

6. The inductor as recited in claim 1, wherein each coil of the plurality of coils has a greater height than its adjacent inner coil along a radius extending from the center.

7. An inductor, comprising:
a conductive material spirally-wound about a center to form a plurality of coils arranged concentrically, wherein the conductive material has a height that varies over its length so that each coil of the plurality of coils has a greater height than its adjacent inner coil along a radius extending from the center.

8. The inductor as recited in claim 7, wherein the height of the conductive material is tapered so that the height of the conductive material increases from a point on the conductive material near the center to a point on the conductive material near on outer portion of the inductor.

9. The inductor as recited in claim 8, wherein the conductive material is tapered symmetrically.

10. The inductor as recited in claim 9, wherein the conductive material is tapered linearly.

11. The inductor as recited in claim 7, comprising:
an electrically insulating strip, wherein the conductive material is disposed on the electrically insulating strip.

12. An inductor, comprising:
a conductor adapted to form a plurality of coils, wherein the plurality of coils has a generally spherical shape.

13. The inductor as recited in claim 12, wherein the conductor has a round cross-section.

14. The inductor as recited in claim 12, wherein the conductor has a rectangular cross-section.

15. The inductor as recited in claim 12, comprising:
an electrical component disposed within the plurality of coils.

16. A method of manufacturing a spherical-shaped inductor, comprising:
disposing a malleable conductor over a spherical form; and
removing the spherical form from inside the spherically-shaped inductor.

17. The method as recited in claim 16, wherein removing the spherical form comprises liquefying the spherical form.

18. The method as recited in claim 17, wherein liquefying comprises heating the spherical form to cause the spherical form to melt.

19. The method as recited in claim 17, wherein liquefying comprises applying a chemical to the spherical form to cause the spherical form to dissolve.

20. The method as recited in claim 16, comprising:
disposing an electrical component within the spherical form.

21. A method of manufacturing a spherical-shaped inductor, comprising:
cutting a conductive material with a pattern, wherein the pattern forms a pair of adjacent spirals in the conductive material;
folding the conductive material at a midpoint between the pair of adjacent spirals; and
displacing each center of the pair of adjacent spirals outward from the midpoint to form a plurality of coils having a spherical shape.

22. An inductor, comprising:
a conductive material operable to produce a magnetic field when an electric current flows therethrough, wherein the conductive material has a height perpendicular to the magnetic field that increases with distance from a region where the magnetic field strength is greatest.

23. The inductor as recited in claim 22, wherein the conductive material is spirally-wound about a center to form a plurality of coils arranged concentrically.

24. The inductor as recited in claim 23, wherein the height of the conductive material is tapered so that the height of the conductive material increases linearly from a point on the conductive material near the center to a point on the conductive material near on outer portion of the inductor.
